(19) United States
(12) Patent Application Publication
(10) Pub. No.: US 2018/0110208 A1
(43) Pub. Date: Apr. 26, 2018

(54) SYSTEM AND METHOD FOR THE POLYCULTURE OF BENTHIC AND PELAGIC AQUATIC ANIMALS USING A STACKED COMBINATION OF DEEP AND SHALLOW HABITATS

(71) Applicant: L&B Patent Inc., Langley (CA)

(72) Inventor: Addison Lee Lawrence, Port Aransas, TX (US)

(73) Assignee: L&B Patent Inc., Langley (CA)

(21) Appl. No.: 15/332,423

(22) Filed: Oct. 24, 2016

(51) Int. Cl. A01K 61/00

(52) U.S. Cl. CPC A01K 61/005; A01K 61/00

(57) ABSTRACT

The present invention relates to ways to deploy stacked habitats in the same building to polyculture benthic and pelagic aquatic animals using super-intensive methods.

### BACKGROUND

### 1. Field

The present invention relates to providing distinct aquacultural habitats, for example deep water and shallow water habitats, and in particular to ways to deploy such habitats in the same building to polyculture benthic and pelagic aquatic animals, for example distinct benthic and pelagic species or distinct benthic and pelagic life stages of the same species, for example for the commercial production of aquatic animals for human consumption.

### 2. Description of Related Art

Raceways, circular tanks, and more generally manufactured habitats of various sizes and shapes, have been deployed inside buildings to provide a desired water environment for more predictable commercial production. However, for conventional technology using water depths greater than three feet, the water mass limits production systems to having only a single layer placed on a slab or floor of the building, such that the space above is unutilized or underutilized.

Because land area and buildings are a major cost, as are physical plant installation and operation, such investments and ongoing expenses can be a significant factor in the profitability of aquaculture facilities. Efficient deployment of habitat can be the difference between profitable and unprofitable facilities.

Culturing more than one species (polyculture) can also be an important factor in profitability, offering multiple sales channels to diversify risks in individual markets and facilitate super-intensive production without saturating any one individual market. One challenge with conventional polyculture is that a shared habitat cannot generally be optimized for all species simultaneously.

Accordingly, what is needed is a better way to deploy habitats, to better utilize the volume of the building, thereby increasing production and profit per area footprint of the building, and for polyculture to diversify the mix of product offerable to the market, thereby mitigating market risk and increasing the level of production.

### SUMMARY

The present invention is directed to these needs.

1. According to one aspect of the present invention, efficient deployment of a habitat of shallow water stacked above a habitat of deep water provides an opportunity for a significant increase is production and profit per unit area of building footprint which, may be the difference between a profitable and unprofitable facility.

2. According to another aspect of the present invention, there is provided a system in which shallow and deep water habitats in stacked raceways and/or tanks of various sizes and shapes are utilized to be able to use the entire volume of an expensive building located on expensive land, thereby providing a possibility of at least one of:

3. allowing the production of different aquatic species that have different habitat requirements (e.g. shallow water of less than 0.6 m and deep water of greater than 0.6 m) optimally in the same building,

4. allowing optimization of a marketing plan,

5. decreasing the size of the building required for commercial aquaculture production,

6. decreasing the area of land required for commercial aquaculture production,

7. decreasing the amount of sea water required per mass of aquatic animal produced,

8. decreasing the amount of waste sea water produced per mass of aquatic animal produced,

9. decreasing the potential for environmental pollution,

10. decreasing the amount of water additives required per mass of aquatic animal produced,

11. increasing the height of the building, which would decrease heat (energy) loss or gain and hence required heating or cooling, and would increase production biomass of aquatic animals per unit footprint area,

12. decreasing the amount of capital investment required per mass of aquatic animal produced,

13. increasing the internal rate of return,

14. decreasing the number of staff required to produce per mass of aquatic animal produced, and

15. decreasing the capital investment required for heating and cooling systems.

According to another aspect of the present invention, there is provided a system in which benthic and pelagic aquatic animals are commercially produced using polyculture of benthic aquatic animals (e.g. shrimp, flounder, sole, sea urchins, sea cucumbers, oysters, abalone, etc.) in one or more shallow habitats, having for example an average water depth of less than 0.6 m, stacked over a deep habitat, for example having an average water depth of more than 0.6 m, containing pelagic aquatic animals (e.g. tilapia, salmon, sea bream, tuna, cobia, squid, jellyfish, etc.), using super-intensive methods.

According to still another aspect of the present invention, there is provided a system having a base, and a first habitat supportable on the base, wherein the base is configured to provide lateral support to the first habitat. The base may included a trough adapted to receive and retain at least a lower portion of the first habitat; the base may include at least one first buttress compressor adapted to laterally urge against at least an upper portion of the first habitat.

The system may further include a second habitat, wherein the base includes at least one second buttress compressor adapted to elevate the second habitat above the first habitat and to laterally urge against at least a portion of the second habitat.

The system may further include a third habitat, wherein the base includes at least one third buttress compressor adapted to elevate the third habitat above the second habitat and to laterally urge against at least a portion of the third habitat.

The first habitat may have at least one of: a square or rounded interior surface at one or both ends, a flat bottom surface, and a longitudinal baffle.

The first habitat may have at least one of: a closed cross-section for at least portion of its length, a crossbeam tensor, an arch tensor, and an arched buttress compressor-tensor. The first habitat may have at least one access, for example extending along the entire side of the habitat.

According to yet another aspect of the present invention, there is provided a system having: a pelagic (deep water) habitat, and a benthic (shallow water) habitat above the pelagic habitat.

The system may further include a building containing the pelagic habitat and the benthic habitats, for example the pelagic habitat at a base level and one or more benthic habitats above the base level.

The system may further include common physical plant, wherein the pelagic habitat and benthic habitat are serviced by the common physical plant.

According to yet a further aspect of the present invention, there is provided a method including: raising at least one species of animal in a pelagic habitat (for example having deep water greater than 0.6 m), and raising at least one species of animal in a benthic habitat above the pelagic habitat (for example having shallow water less than 0.6 m).

At least one species raised in the pelagic habitat may be different from the at least one species raised in the benthic habitat. For example, the at least one species raised in the pelagic habitat may be tilapia and the at least one species raised in the benthic habitat may be shrimp.

At least one species raised in the pelagic habitat may be the same as the at least one species raised in the benthic habitat, but at a different stage of life.

For example, raising at least one species of animal in a pelagic habitat may include raising newly hatched shrimp larvae to typically 7 to 20 day-old postlarvae (PL7 to PL20), and raising at least one species of animal in a benthic habitat above the pelagic habitat may include raising postlarvae shrimp typically older than PL7 to PL20. Raising postlarvae shrimp typically older than PL7 to PL20 may include at least one of: raising juvenile shrimp, raising sub-adult shrimp, and raising adult shrimp.

More particularly, raising at least one species of animal in a pelagic habitat may include raising newly hatched shrimp larvae to typically 9 to 15 day-old postlarvae (PL9 to PL15), and raising at least one species of animal in a benthic habitat above the pelagic habitat may include raising postlarvae shrimp typically older than PL9 to PL15. Raising postlarvae shrimp typically older than PL9 to PL15 may include at least one of: raising juvenile shrimp, raising sub-adult shrimp, and raising adult shrimp.

More particularly, raising at least one species of animal in a pelagic habitat may includes raising newly hatched shrimp larvae to typically 10 to 12 day-old postlarvae (PL10 to PL12), and raising at least one species of animal in a benthic habitat above the pelagic habitat may include raising postlarvae shrimp typically older than PL10 to PL12. Raising postlarvae shrimp typically older than PL 10 to PL12 may include at least one of: raising juvenile shrimp, raising sub-adult shrimp, and raising adult shrimp.

Those skilled in the art will appreciate that these ranges recognize that some stages of life can be challenging to determine precisely and that not all animals in a habitat will progress through life stages at precisely the same time. Those skilled in the art will appreciate that habitat decisions, such as when to move animals from a pelagic habitat to a benthic habitat, are influenced by process optimization, the progress of the particular animals currently being raised, and current market conditions, for example whether the market is currently demanding PL7, PL 9, PL10, PL 12, PL15 or PL20 shrimp.

Shrimp larvae and postlarvae when they initially metamorphose into postlarvae are pelagic and prefer the deep water or pelagic habitat. Postlarvae gradually become more and more benthic preferring shallow water as they grow older. By the time they are referred to as juvenile shrimp they completely prefer shallow water or the benthic habitat. This change from preferring a pelagic habitat (deep water) to a benthic habitat (shallow water) is gradual. Thus, shrimp larvae and postlarvae as long as they are predominantly pelagic, which is to about an eight to fifteen day-old postlarvae, are conventionally usually raised in pelagic or deep water habitats. However, these young postlarvae from about eight to fifteen day-old to about 24 to 50 days-old are now predominantly benthic and are usually raised in shallow water or benthic habitat. From the juvenile life stage to the adult life stage the shrimp are completely benthic and can be raised in shallow water or a benthic habitat. Conventionally, building facilities are designed and constructed to raise shrimp larvae typically to about eight to fifteen day-old postlarvae in deep water or pelagic habitats. The eight to fifteen day-old postlarvae are then transferred to production facilities and are reared to harvestable size (to about 24 to 50 day-old postlarvae to adult life stages) for sale in one or successive shallow water or benthic habitats.

The present teachings provide an opportunity to conveniently raise shrimp in their pelagic stage (larvae to about seven to twenty day-old postlarvae) in the deeper water or pelagic habitats using the first (base) habitat and in their predominantly benthic shallow water habitat preferring older postlarvae life stage to completely shallow water benthic habitat preferring juvenile to adult life stages in a shallower water second habitat, third habitat and beyond, as the case may be.

Further aspects and advantages of the present invention will become apparent upon considering the following drawings, description, and claims.

### DESCRIPTION

The invention will be more fully illustrated by the following detailed description of non-limiting specific embodiments in conjunction with the accompanying drawing figures. In the figures, similar elements and/or features may have the same reference label. Further, various elements of the same type may be distinguished by following the reference label with a second label that distinguishes among the similar elements. If only the first reference label is identified in a particular passage of the detailed description, then that passage describes any one of the similar elements having the same first reference label irrespective of the second reference label.

### BRIEF DESCRIPTION OF THE DRAWINGS

FIG. 1 is a top-front-right oblique view of a first embodiment of a habitat system in accordance with aspects of the present invention.

FIG. 2 is an exploded top-front-right oblique view of the system of FIG. 1.

FIG. 3 is a top-front-right oblique view of a second embodiment of a habitat system in accordance with aspects of the present invention.

FIG. 4 is a top-front-right oblique view of a third embodiment of a habitat system in accordance with aspects of the present invention, the system having a base habitat.

FIG. 5 is an exploded top-front-right oblique view of the system of FIG. 4.

FIG. 6 is a top-rear-left oblique view of the base habitat of the system of FIG. 4.

FIG. 7 is a top-front-right oblique view of a fourth embodiment of a habitat system in accordance with aspects of the present invention, the system having a base habitat.

FIG. 8 is a top-front-right oblique view of a first variant of the system of FIG. 1.

FIG. 9 is a top-front-right oblique view of a second variant of the system of FIG. 1.

FIG. 10 is a top-front-right oblique view of a third variant of the system of FIG. 1.

FIG. 11 is a top-front-right oblique view of a fourth variant of the system of FIG. 1.

### DETAILED DESCRIPTION OF SPECIFIC EMBODIMENTS

### A. Introduction and General Teachings

Benthic aquatic animals (preferring shallow water) such as flounder, sole, sea urchins, sea cucumbers, oysters, abalone, or late postlarvae to juvenile to sub-adult to adult shrimp, etc., can be commercially produced using an average water depth of less than 0.6 m, which depth is in contrast to pelagic aquatic animal species (preferring deep water) such as tilapia, salmon, sea bream, tuna, cobia, squid, jellyfish, or early life stages of aquatic animal species such as shrimp larvae and young postlarvae etc., which require average water depths greater than 0.6 m for commercial production.

Thus by polyculturing pelagic animals in habitats that contain an average water depth of over 0.6 m and that are supported either on a slab surface or below the surface of the slab, and by polyculturing benthic aquatic animals in habitats containing an average water depth of less than 0.6 m, one can cost-effectively stack benthic habitats above pelagic habitats. Thus, the total volume in a building can be more effectively utilized, increasing production per footprint area, decreasing land use, decreasing production cost and increasing the return on investment. This arrangement also allows one to consider increasing the height of the building, which provides an opportunity to increase the number of levels of stacked raceways or tanks, thus increasing production per footprint area and at the same time offering other advantages such as a decrease heating and/or cooling cost per unit production of aquatic animals.

The commercial culture of many pelagic animals utilizing only a single layer of deep habitat either below the slab surface or on the slab surface is marginally commercial because of the high capital cost associated with the building and land. The polyculture of the pelagic animals with benthic animals now makes the commercial production of many pelagic animals feasible which if monocultured might not provide an adequate return on investment for commercialization.

One culture might mainly satisfy a local market and pay mainly for investment and operating costs, while another culture might satisfy a lucrative export market and generate the bulk of profits. Thus for example, one might cover capital investment and operating costs through sales of one culture into a commodity market, while generating profits through sales of another culture into a more lucrative premium market. Different sizes and qualities of each culture might be directed appropriately to either a local (perhaps commodity) market or an export (perhaps premium) market. With the land, building and common physical plant already in place, the marginal cost to provide for another culture may be minor. The teachings herein provide, for example, for the simultaneous raising of high mass, low value (commodity) pelagic cultures (e.g. tilapia) and low mass, high value benthic cultures (e.g. abalone).

In this regard, there will be taught a method and system for the aquaculture of pelagic animals by stocking the seed stock (e.g. fish fry) into habitats containing an average water depth of at least 0.6 m. Additional habitats containing an average water depth of more than 0.6 m are challenging to stack above such habitats, because of the cost of building sufficient structures to support and contain such heavy volumes of water. The mass of such water, and the momentum of moving water, can make it challenging contain, risking breaching or toppling habitats, for example. These challenges increase with the depth and volume of contained water.

Therefore, the method and system taught instead also provide for the aquaculture of benthic animals by stocking seed stock of some species (e.g. fish fry, late or older postlarval shrimp, oyster spat, etc.) into habits containing an average water depth of less than 0.6 m. With this smaller required water depth and decrease water weight, additional levels (tiers) of raceways or tanks of various sizes and shapes (i.e. habits) can now be stacked above the bottom pelagic habitat. For example, two to fifteen tiers (levels) of habits might be cost-effectively stacked above this bottom habitat. Those skilled in the art will appreciate that the number of additional tiers of habitats stacked above the bottom habitat would depend upon the ceiling height of the surrounding building, depth of the shallow water, species of benthic aquatic animal, site characteristics, etc.

The polyculture of benthic with pelagic animals—or multiple species of benthic or pelagic animals—in the same water column has not proven successful in general. The reason for this is that the culture conditions for two or more species in the same water column is not optimum for all the species being commercially cultured. Thus, polyculture of more than one species in the same water column is unlikely to increase margin and return on investment, but may well instead decrease the margin. In contrast, the teachings herein of polyculturing more than one species in the same building but with only one species per habitat, allow the culture conditions to be optimized for the single species in each habitat, and may yield higher margins and better return on investment, thus making such methods and systems realizable. The preceding production issues are also true for polyculturing early life stages of some species (e.g. shrimp larvae and early or young postlarvae) with older life stages of even the same species, but in addition the older life stages might eat the younger life stages, thus further decreasing production.

The commercial aquaculture of more than one species simultaneously in the same building can offer many significant marketing advantages as well as better utilizing the total volume within the building and thus providing an opportunity to increase the return on investment. The number of different pelagic and benthic species with only a single species being cultured in a single habitat may be for example one pelagic and one benthic species, ten pelagic and ten benthic species in the same building, or otherwise.

Thus, in general terms, there will be taught examples of manufactured habitats of various sizes, shapes and configurations (e.g. raceways, tanks) that can be deployed as shallow (water depth 0.6 m or less) and deep (water depth of 0.6 m or more) habitats, having various types of bottom (e.g. level or sloped, symmetrically or asymmetrically), and with or without a center partition (e.g. solid, net, or wall of air bubbles). The habitats may be rectangular, square, obround, circular, elliptical, oblong, or other shapes, whether polygonal, conic, regular, irregular, or otherwise.

The bottom habitat may generally contain an average water depth of between one and two meters but may be lower (e.g. 0.6 meters) or higher (e.g. four meters), for example. The top of the bottom habitat may be level with the surface of a slab supporting it, or the bottom of the bottom habitat may be level with the surface of the slab, or the bottom habitat may be leveled in between these two levels, for example.

The perimeter of such habitats may be rectangular, rectangular with rounded ends or oval, for example. Such habitats may be configured as raceways, for example, having a width, length and height between 1 meter and 10 meters, 2 meters and 100 meters, and 0.2 meters and 4 meters, respectively, for example.

The bottom of the habitats may be level or sloped, with a bottom nadir or a bottom apex, for example, or a combination.

There may be a central vertical partition in the habitat extending through 50% to 98% of the total length of the habitat. This vertical partition may be solid and made of the same material as the walls and bottoms of the habitat or just a vertical net, for example suspended from above the habitat (for example the bottom of a habitat stacked above it) and extending to an appropriate desired depth into the habitat, or a wall of air bubbles generated by one or more air diffuser tubes.

There may be one or more sumps in the habitat, for example at extrema, for example at one or both ends, to aid in removing waste and to assist in harvesting. The sump may be 0.2 meters to 10 meters wide by 1 meter to 10 meters long and 0.2 meters to 2 meters deep, for example. The sump bottom may be with a bottom nadir or level or partially slope and level.

If configured as tanks, for example circular tanks, the diameter of such habitats may be between two meters and twenty meters, for example. The height of the shallow and deep circular tank wall may be between 0.2 meters and 4 meters, for example.

The bottom of such circular tanks may be level, or sloped, with a bottom nadir or a bottom apex, for example.

Such circular tanks may include a sump, located for example in the center of the bottom, to aid in removing solid waste and to assist in harvesting. The sump may be 0.2 meters to three meters in diameter and 0.2 meters to 2 meters deep. The sump bottom may be with a bottom nadir or level or partially slope and level. There may be an additional sump at the side of the circular tank to aid in removing waste and to assist in harvesting. The sides of this additional sump may either be straight with the outer sides the shape of the circular tank side or with the inner side being straight to the same shape of the circular tank side. This additional sump may be 0.2 to 2 meters deep with the bottom being bottom nadir or bottom apex.

Those skilled in the art will recognize that various types of habitat might be stacked, for example one or more shallow raceways above a deep tank or one or more shallow tanks above a deep raceway.

These teachings provide various raising and harvesting options. One could raise a species of animals from a smaller size to a larger size in one habitat, at which time they could be transferred to another habitat at a lower stocking density until they are harvested. Benthic and pelagic species may be completely harvested for a habitat if only one size per habitat is desired, or may be partially harvested when the aquatic animal reaches a minimal desired harvestable size as many times as desired until they reach the maximum desired size, at which time they would be completely harvested.

### B. Structure of Specific Embodiments

### First Embodiment

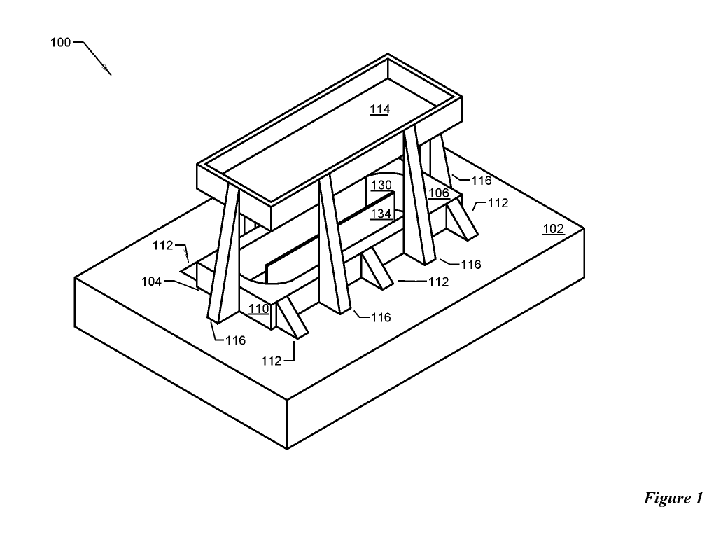

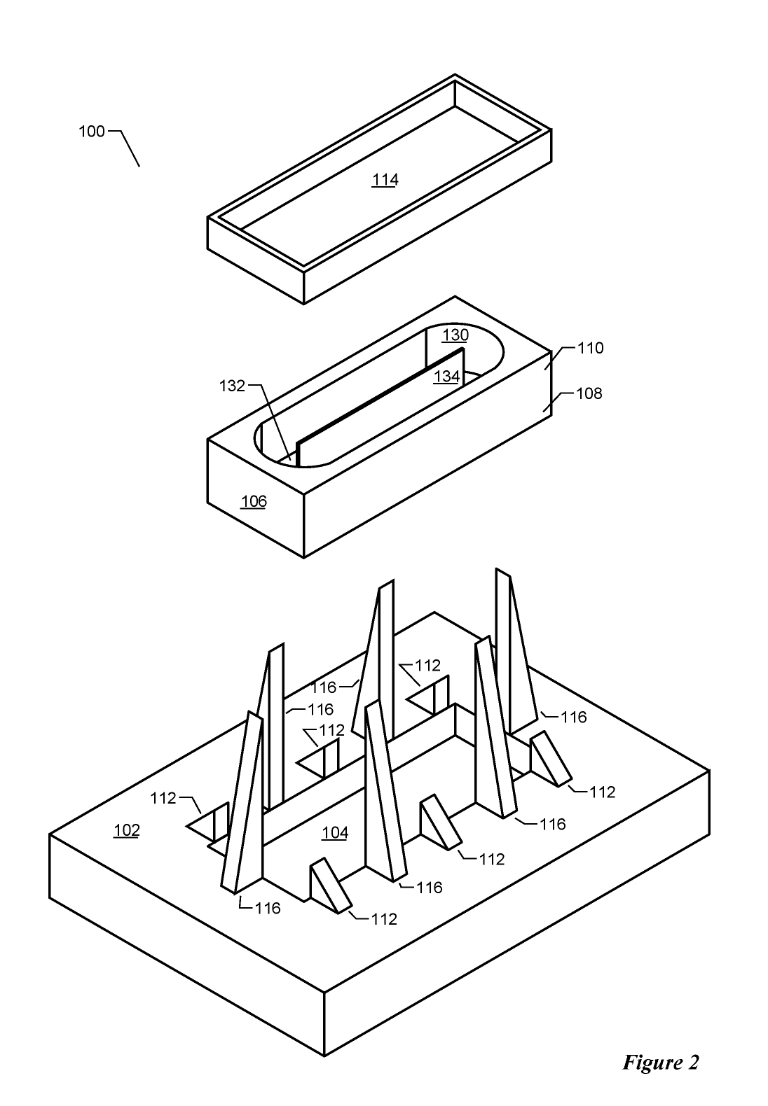

FIGS. 1 and 2 show a habitat system according to a first embodiment of the present invention, generally illustrated at 100, plumbing and other conventional subsystems having been omitted to improve clarity. As illustrated, the first habitat system 100 may be configured as raceways; however, those skilled in the art will appreciate that other configurations are also possible, for example tanks, for example circular tanks, or pens. As illustrated, the first habitat system 100 may be configured as level-bottom raceways; however, those skilled in the art will appreciate that other configurations are also possible, for example sloped-bottom raceways, for example a sloped-bottom raceway having a bottom apex 132′ (see FIG. 10) or a sloped-bottom raceway having bottom nadir 132″ (see FIG. 11).

The first habitat system 100 has a supporting base 102, which may be natural, for example earthen, or manufactured, for example a cast slab or a floor, and which includes a trough 104 adapted to provide strong lateral support.

The first habitat system 100 also includes a first habitat 106 that is sized and shaped to be received and retained within the trough 104 for lateral support therewithin. As illustrated, the first habitat 106 has a lower portion 108 and an upper portion 110, wherein the lower portion 108 is sized and shaped to be received and retained within the trough 104 for lateral support therewithin, while the upper portion 110 lies above the base 102.

The base 102 may also support at least one first buttress compressor 112 in a position to urge against and provide lateral support to the upper portion 110 of the first habitat 106. (0077) The first habitat system 100 may also include a second habitat 114 that is shallower, or at least no deeper, than the first habitat 106. The base 102 also supports at least one second buttress compressor 116 in a position to elevate the second habitat 114 above the first habitat 106 and to provide lateral support. Those skilled in the art will recognize that the second buttress compressor 116 may also provide lateral support to the first habitat 106 if positioned adjacently, as illustrated. Alternatively, instead of using buttress compressors 112, 116, one might deploy vertical support beams, for example in combination with cross beams.

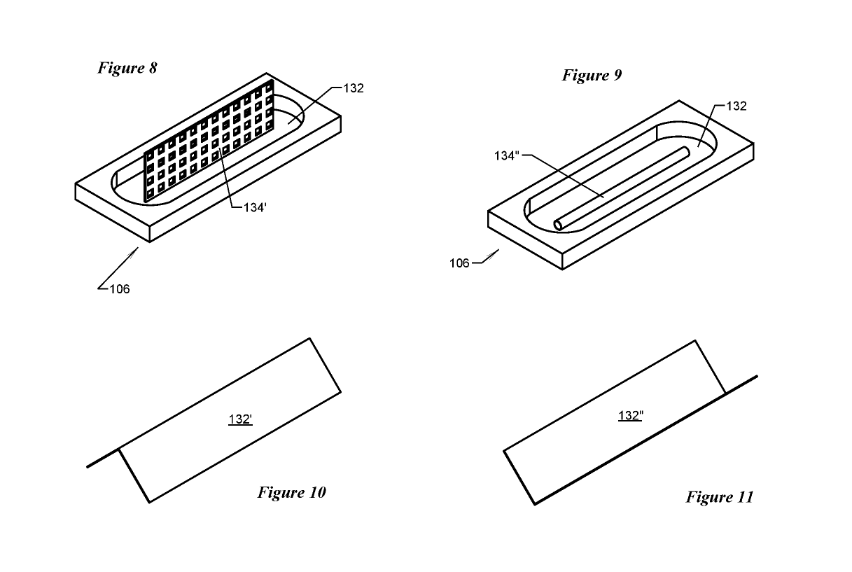

The first habitat 106 may further have at least one end 130 with a rounded interior surface, a flat bottom 132, and a longitudinal baffle 134, all to reduce the turbulence in the flow of liquid within the first habitat 106, for example to reduce shock. In some embodiments, the longitudinal baffle 134 may include or be implemented as a net 134′ (see FIG. 8) or a wall of air bubbles, for example as generated using one or more air diffuser tubes 134″ (see FIG. 9).

### Second Embodiment

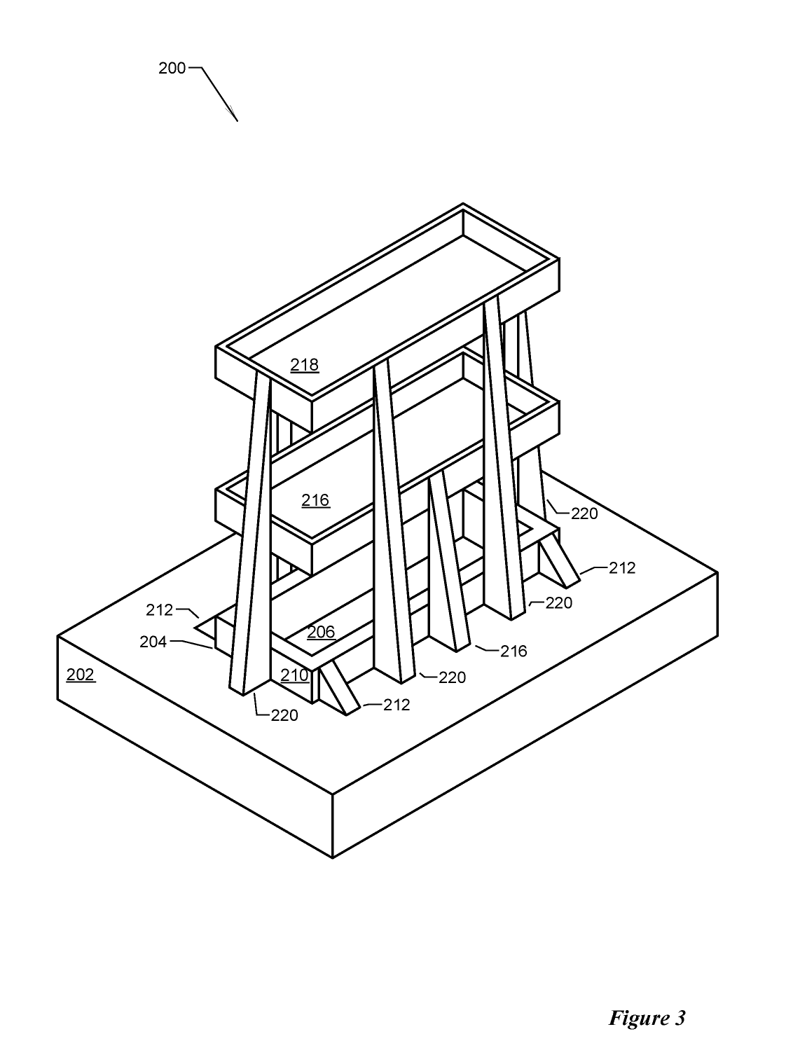

FIG. 3 shows a habitat system according to a second embodiment of the present invention, generally illustrated at 200, plumbing and other conventional subsystems having been omitted to improve clarity.

The second habitat system 200 is similar to the first habitat system 100, but further includes a third habitat 218 that is shallower, or at least no deeper, than the first habitat 206 and the second habitat 214. The base 202 also supports at least one third buttress compressor 220 in a position to elevate the third habitat 218 above the first habitat 206 and the second habitat 214 and to provide lateral support. Those skilled in the art will recognize that the third buttress compressor 220 may also provide lateral support to the first habitat 206 and second habitat 214 if positioned adjacently, as illustrated.

### Third Embodiment

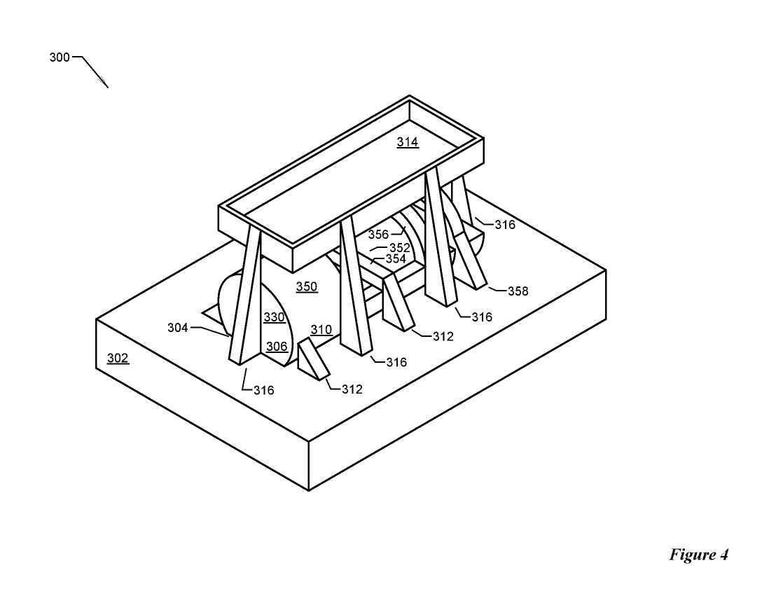

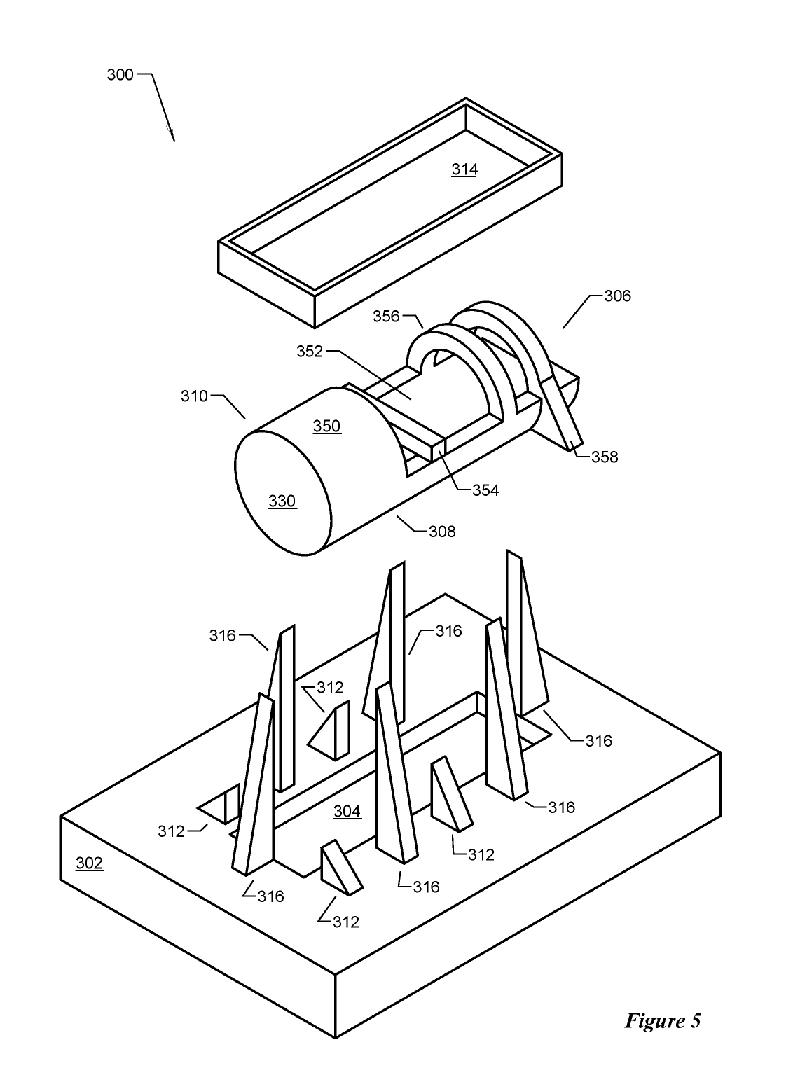

FIGS. 4 to 6 show a habitat system according to a third embodiment of the present invention, generally illustrated at 300, plumbing and other conventional subsystems having been omitted to improve clarity.

The third habitat system 300 is similar to the first habitat system 100 and the second habitat system 200, but includes some differences in the first habitat 306 and its lateral supports. Broadly, the third habitat system 300 may include tank configurations, which may supplement or replace external lateral support, for example from compressors such as buttresses, with internal tensile bracing.

For example, the first habitat 306 may have a fully closed cross-section 350 for at least a portion of its length, having a pipe-like configuration, with closed ends 330 as illustrated. The closed cross-section 350 of the first habitat 306 may be interrupted by at least one access 352 to the interior of the first habitat 306. Bracing may be provided as well or instead by, for example, a crossbeam tensor 354, an arch tensor 356 (that may or may not follow the common cross-section of the first habitat 306, or a combined arched buttress compressor-tensor 358 that may or may not be a part of the first habitat 306.

Those skilled in the art will recognize that such tensile elements may be deployed on other habitats as well, for example the second habitat 314.

Those skilled in the art will recognize that the deployment of supplemental, replacement or in general alternative lateral supports may allow buttress-compressors to function primarily or solely as or to be replaced by simple columns to simply support habitats at a desired elevation.

### Fourth Embodiment

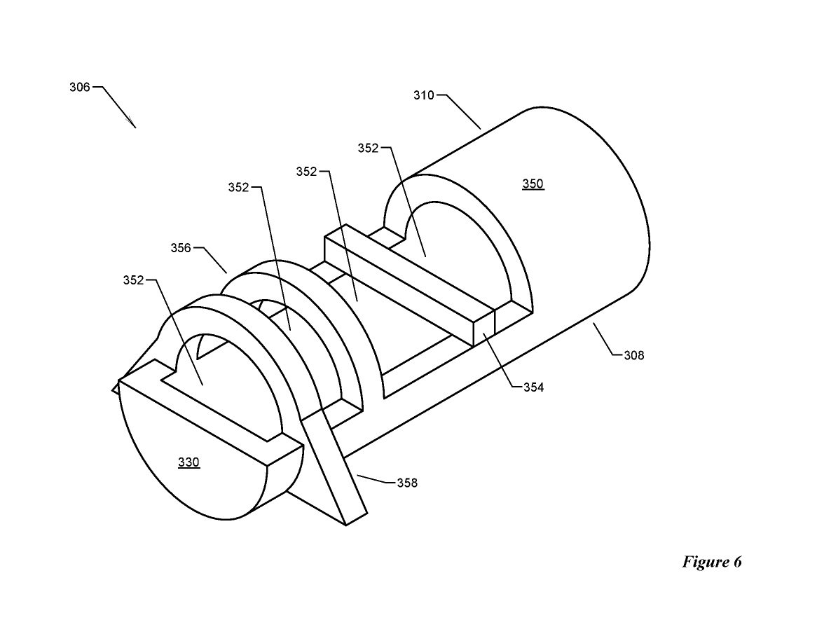

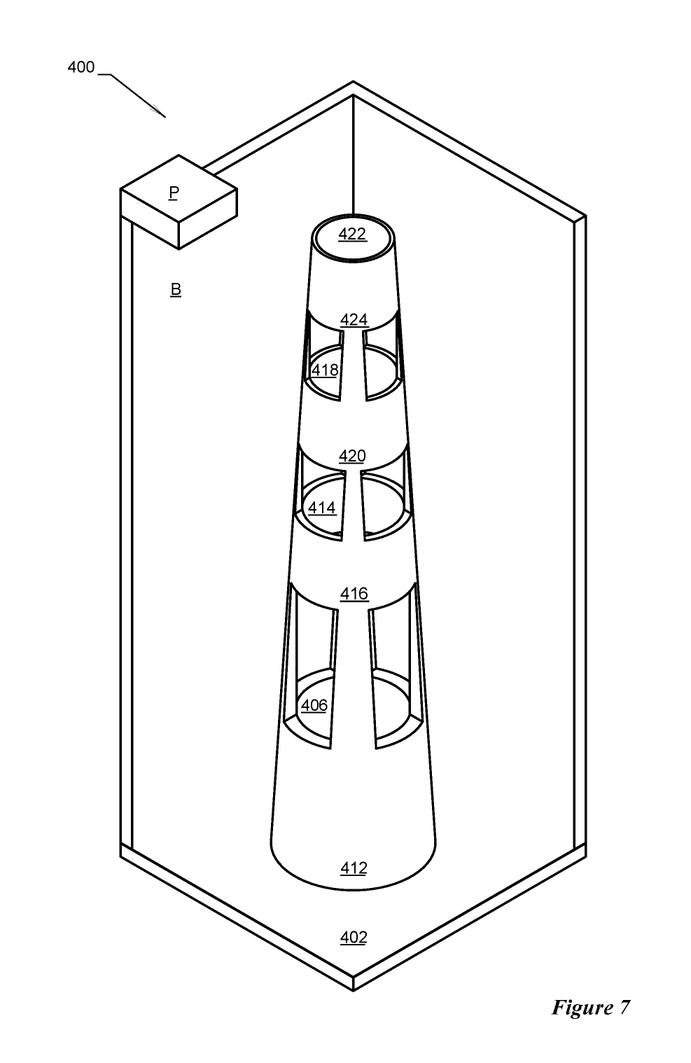

FIG. 7 shows a habitat system according to a fourth embodiment of the present invention, generally illustrated at 400, plumbing and other conventional subsystems having been omitted to improve clarity.

The fourth habitat system 400 is similar to the first habitat system 100, the second habitat system 200 and the third habitat system 300, but is embodied as a stack of top-opening tanks that may be conventionally cylindrical or, as illustrated, conical, supported on a base 402. As illustrated, the tanks are stacked coaxially; however, they need not be. As illustrated, higher volume tanks have thicker walls to better resist outward forces applied by their contents; however, those skilled in the art will appreciate that other arrangements could be suitable for resisting such forces, whether through tension or compression for example. The fourth habitat system 400 may have a first habitat 406, a second habitat 414 there above, a third habitat 418 there above, and a fourth habitat 422 there above, respectively retained in place by a first buttress compressor 412, a second buttress compressor 416, a third buttress compressor 420 and a fourth buttress compressor 424.

The fourth habitat system 400 is illustrated contained within a building B, that provides common physical plant P to each of the habitats 406, 414, 418, 422, for example HVAC.

### Operation of Specific Embodiments

With reference now to FIGS. 1 to 7, the construction of these specific embodiments of the invention will now be described.

In general, the base 102, 202, 302, 402 will be constructed or provided, sufficient to support the weight of the system 100, 200, 300, 400 including production animals (not shown) and growth media (not shown), including water, feed, treatment chemicals, and system components (shown and not shown). The base 102, 202, 302 may include a trough 104, 204, 304 to receive and retain at least a lower portion 108, 208, 308 of the first habitat 106, 206, 306 and provide external compressive lateral support against outwardly radiating forces exacted on the first habitat 106, 206, 306, both static and dynamic, by the production animals (not shown), growth media (not shown) and system components (shown and not shown). The dynamic forces can be further mitigated by configuring the first habitat 106, for example, with at least one rounded end 130, a flat bottom 132 and a longitudinal baffle 134 to reduce turbulence in the growth media.

Additional external compressive lateral support may be provided to the first habitat 106, 206, 306, 406, and in particular the upper portion 110, 210, 310 of the first habitat 106, 206, 306, by at least one first buttress compressor 112, 212, 312, 412.

Other habitats, for example the second habitat 114, 214, 314, 414, the third habitat 218, 418, the fourth habitat 422 (and beyond) may be elevated above first habitat 106, 206, 306, 406, for example by respectively at least one second buttress compressor 116, 216, 316, 416, at least one third buttress compressor 220, 420 and at least one fourth buttress compressor 424. Those skilled in the art will recognize that separate components can be used to elevate habitats and provide compressive lateral support, and that the combination of these functions in a single component is just one convenient implementation.

The stability of the system 100, 200, 300, 400 is improved by lowering its center of gravity by locating a habitat having (or configured to have) a larger volume of medium or a deeper depth of medium below a habitat having (or configured to have) a smaller volume of medium or a shallower depth of medium.

Some habitats, for example the first habitat 306, may be constructed with internal tensile bracing, for example deploying: a closed cross-section 350 with or without at least one interrupting access 352, a crossbeam tensor 354, an arch tensor 356, or an arched buttress compressor-tensor 358, alone or in combination.

So constructed, the habitat systems 100, 200, 300, 400 may be operated to host a pelagic species in the first habitat 106, 206, 306, 406 and a benthic species in each of the habitats there above, for example the second habitat 114, 214, 314, 414, the third habitat 218, 418, the fourth habitat 422, and beyond, as the case may be.

The present teachings can be advantageously extended to polyculturing different stages of the same species. For example, shrimp larvae and postlarvae when they initially metamorphose into postlarvae are pelagic and prefer the deep water or pelagic habitat 106, 206, 306, 406. Postlarvae gradually become more and more benthic preferring shallow water as they grow older. By the time they are referred to as juvenile shrimp they completely prefer shallow water or the benthic habitat 114, 214, 314, 414, 218 418, 422. This change from preferring a pelagic habitat 106, 206, 306, 406 (deep water) to a benthic habitat 114, 214, 314, 414, 218 418, 422 (shallow water) is gradual.

Thus, shrimp larvae and postlarvae as long as they are predominantly pelagic, which is to about an seven to twenty day-old postlarvae, are conventionally usually raised in deep water or pelagic habitat 106, 206, 306, 406. However, these young postlarvae from about seven to twenty day-old to about 24 to 50 days-old are now predominantly benthic and are usually raised in shallow water or benthic habitat 114, 214, 314, 414, 218 418, 422. From the juvenile life stage to the adult life stage the shrimp are completely benthic and can be raised in shallow water or a benthic habitat 114, 214, 314, 414, 218 418, 422.

Conventionally, building facilities are design and constructed to raise shrimp larvae typically to about eight to fifteen day-old postlarvae in deep water or pelagic habitats 106, 206, 306, 406. The eight to fifteen day-old postlarvae are then transferred to production facilities and are reared to harvestable size (to about 24 to 50 day-old postlarvae to adult life stages) for sale in one or successive shallow water or benthic habitats 114, 214, 314, 414, 218 418, 422.

The present teachings provide an opportunity to conveniently raise shrimp in their pelagic stage (larvae to about seven to twenty day-old postlarvae) in the deeper water or pelagic habitats 106, 206, 306, 406 using the first (base) habitat and in their predominantly benthic shallow water habitat preferring older postlarvae life stage to completely shallow water benthic habitat preferring juvenile to adult life stages in the shallower water second habitat 114, 214, 314, 414, the third habitat 218 418, the fourth habitat 422, and beyond, as the case may be.

### Description Summary

Thus, it will be seen from the foregoing embodiments and examples that there has been described a way to deploy habitats in the same building to polyculture benthic and pelagic aquatic animals using super-intensive methods.

While specific embodiments of the invention have been described and illustrated, such embodiments should be considered illustrative of the invention only and not as limiting the invention as construed in accordance with the accompanying claims.

It will be understood by those skilled in the art that various changes, modifications and substitutions can be made to the foregoing embodiments without departing from the principle and scope of the invention expressed in the claims made herein.

For example, where a building has multiple storeys and the floor system of an upper storey is sufficiently robust, a deeper, pelagic habitat may be in effect stacked above a shallower benthic habitat, if, for example, the pelagic habitat is supported on that upper storey robust floor, above the storey on which the benthic habitat is located.

For example, a habitat stacked above another habitat need not be located directly above the another habitat.

For example, where two or more habitats are stacked above another habitat, the two or more habitats may be adjacent or otherwise at the same elevation and need not be stacked one above the other.

For example, a habitat may be located above another habitat through arrangements other than support from below as illustrated, for example by suspension from above or cantilevering from beside.

For example, a habitat may be equipment removably placed in a building, or an inbuilt fixture of the building.

1-8. (canceled)

9. An aquaculture system comprising:
a. a pelagic habitat adapted to raise a pelagic life stage of a first species of animal, wherein the pelagic habitat comprises a level-bottom raceway having a depth of greater than 0.6 m, and
b. a benthic habitat adapted to raise a benthic life stage of a second species of animal above the pelagic habitat, wherein the benthic habitat comprises a level-bottom raceway having a depth of less than 0.6 m,
wherein the pelagic and benthic habitats are in a stacked configuration.

10. The aquaculture system of claim 9, further comprising a building containing the pelagic habitat and the benthic habitat.

11. A The aquaculture system of claim 9, further comprising a common physical plant, wherein the pelagic habitat and benthic habitat are serviced by the common physical plant.

12. A method of aquaculture comprising:
raising a pelagic life stage of a first species of animal in a pelagic habitat, wherein the pelagic habitat comprises a level-bottom raceway having a depth of greater than 0.6 m, and
raising a benthic life stage of a second species of animal in a benthic habitat above the pelagic habitat, wherein the benthic habitat comprises a level-bottom raceway having a depth of less than 0.6 m,
wherein the pelagic and benthic habitats are a stacked configuration.

13. The method of claim 12, wherein the first species of animal raised in the pelagic habitat is a different species of animal compared to the second species of animal raised in the benthic habitat.

14. The method of claim 13, wherein the first species of animal raised in the pelagic habitat is tilapia and the second species of animal raised in the benthic habitat is shrimp.

15. (canceled)

16. The method of claim 12, wherein the first species of animal raised in the pelagic habitat and the second species of animal raised in the benthic habitat are both shrimp species.

17. The method of claim 16, wherein:
raising the first species of animal in the pelagic habitat comprises raising newly hatched shrimp larvae to 7 to 20 day-old postlarvae (PL7 to PL20), and
raising the second species of animal in the benthic habitat above the pelagic habitat comprises raising postlarvae shrimp older than PL7 to PL20.

18. The method of claim 17, wherein raising postlarvae shrimp typically older than PL7 to PL20 comprises at least one of:
raising juvenile shrimp,
raising sub-adult shrimp, or
raising adult shrimp.

19. The method of claim 16, wherein:
raising the first species of animal in the pelagic habitat comprises raising newly hatched shrimp larvae to 9 to 15 day-old postlarvae (PL9 to PL15), and
raising the second species of animal in the benthic habitat above the pelagic habitat comprises raising postlarvae shrimp older than PL9 to PL15.

20. The method of claim 19, wherein raising postlarvae shrimp typically older than PL9 to PL15 comprises at least one of:
a. raising juvenile shrimp,
b. raising sub-adult shrimp, or
c. raising adult shrimp.

21. The method of claim 16, wherein:
raising the first species of animal in the pelagic habitat comprises raising newly hatched shrimp larvae to 10 to 12 day-old postlarvae (PL10 to PL12), and
raising the second species of animal in the benthic habitat above the pelagic habitat comprises raising postlarvae shrimp older than PL10 to PL12.

22. The method of claim 21, wherein raising postlarvae shrimp typically older than PL10 to PL12 comprises at least one of:
raising juvenile shrimp,
raising sub-adult shrimp, or
raising adult shrimp.
